(19) United States
(12) Patent Application Publication
(10) Pub. No.: US 2023/0111723 A1
(43) Pub. Date: Apr. 13, 2023

(54) HEAT PROBE

(71) Applicant: Sunbeam Products, Inc., Boca Raton, FL (US)

(72) Inventor: Enrique Plazarte, Fort Lauderdale, FL (US)

(21) Appl. No.: 17/905,036

(22) PCT Filed: Feb. 25, 2021
(86) PCT No.: PCT/US21/19666

§ 371 Date: Aug. 25, 2022

Related U.S. Application Data
(60) Provisional application No. 62/981,108, filed on Feb. 25, 2020.

(51) Int. Cl. H05B 1/02; H05B 3/44; H05B 3/00; G01K 13/00

(52) U.S. Cl. CPC H05B 1/0263; H05B 3/44; H05B 3/0004; G01K 13/00; G01K 2207/06

(57) ABSTRACT

A heated probe is provided that cooks food from the inside-out in order to help reduce cooking times. The probe may be used within an oven, or it may be used as a standalone cooking source. The probe may include heat control, such that foods may be cooked at a low temperature for extended periods of time without drying out the food. Such heat control may help keep proteins tender to produce a result similar to proteins cooked in a sous vide style.

### CROSS REFERENCE TO RELATED APPLICATIONS

This application claims priority to U.S. Application No. 62/981,108 filed Feb. 25, 2020 and titled “HEAT PROBE.” U.S. Application No. 62/981,108 is hereby fully incorporated by reference as if set forth fully herein.

### BACKGROUND OF THE INVENTION

Conventional cooking methods generally involve cooking of foods from the outside-in. For example, such methods often include using infrared radiation, convection, and/or conduction cooking methods. With the emerging trends of healthy eating, consumers are looking for more ways to cook at home, but want the process to be convenient and fast. There are ovens in the marketplace that use a combination of microwave, convection, and infrared heating. However, many such options are cost prohibitive and have not been implemented in a small package for a countertop oven. As such they are not inexpensive or convenient enough to meet the needs of the marketplace.

### SUMMARY OF THE INVENTION

The apparatus hereof provides a heated probe that may be used in tandem with an oven, or as a standalone cooking source. The probe cooks food from the inside-out, so as to cut down on cooking time. The probe further includes heat control, such that foods may be cooked at a low temperature for extended periods of time without drying out the food. This may help to make proteins more tender, for a result similar to proteins cooked in a sous vide style.

Some embodiments described herein can be directed to a cooking system that includes a probe configured to be inserted into a food product and a power source that when activated is configured to increase a temperature of the probe to a preconfigured temperature such that the temperature of the probe is a function of an amount of power supplied by the power source. In some embodiments, the heat element can be housed within a body of the probe and can be in communication with the power source for powering the heat element when the power source is activated. In such embodiments, when activated, the power source can be configured to supply the amount of power to the heat element such that the heat element raises the temperature of the probe to the preconfigured temperature. In some embodiments, the probe includes a distal end portion for aiding insertion of the probe into a food product. In some embodiments, the heat element is a cartridge heater. Additionally, the probe can include a proximal end portion having a stop member having a diameter greater than a diameter of the body so as to help prevent the probe from being over-inserted into the food product. The probe can also include various temperature monitoring components such as at least one thermistor with the probe to measure a temperature of the food product, a first heating probe body a separate, a first temperature sensing probe body, and/or a second temperature sensing probe body. In some embodiments, the power source can be included in an oven and the oven can include a control panel for setting the preconfigured temperature and activating the power source. In some embodiments, the power source is a battery.

Other embodiments described herein can be directed to a method including the steps of inserting a probe into a food product, and activating a power source to increase a temperature of the probe to a preconfigured temperature such that the temperature of the probe is a function of an amount of power supplied by the power source. The methods can also include receiving temperature readings of the food product at a controller for the power source, and the controller altering the amount of power supplied by the power source in response to the temperature readings. In some embodiments, the method can include receiving the temperature readings of the food product from the probe. Additionally or alternatively, in some embodiments, the method can include receiving temperature readings of the food product from a first temperature sensing probe body of the probe which is separate from a first heating probe body of the probe. In some embodiments, the method can include the controller adjusting operating parameters of other cooking elements in response to the temperature readings. The power source and the other cooking elements can be contained within an oven and the other cooking elements can include one or more of a fan and an oven heating element. Similarly, in some embodiments, the controller can track an amount of time that the power source has been activated and can alter the amount of power supplied by the power source and adjust operating parameters of other cooking elements in response to either or both of the amount of time and the temperature readings. Additionally, in some embodiments, the controller can adjust only the amount of power supplied by the power source in response to the amount of time the power source has been activated.

### BRIEF DESCRIPTION OF THE DRAWINGS

For a better understanding of the present invention, reference may be made to the following accompanying drawings.

FIG. 1 is a perspective view of an oven with a heated probe therein, constructed according to the teachings hereof.

FIG. 2 is an elevation view of the heated probe of FIG. 1.

FIG. 3 is a schematic of a cartridge heater of the heated probe of FIG. 2.

FIG. 4 is a first embodiment of the heated probe of FIG. 2.

FIG. 5 is a second embodiment of the heated probe of FIG. 2.

FIG. 6 is a third embodiment of the heated probe of FIG. 2.

FIG. 7 is a partial phantom view of the heated probe of FIG. 6

FIG. 8 is an exploded view of some of the components of the heated probe of FIG. 6.

### DETAILED DESCRIPTION OF THE INVENTION

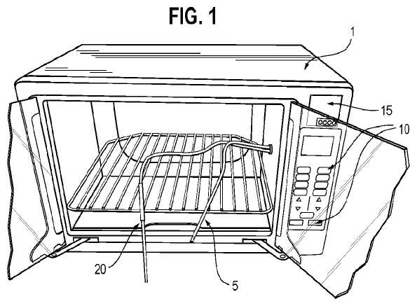

Turning to FIG. 1, an oven 1 is illustrated that includes a heated probe 5. The heated probe 5 may, with the oven, work to cook a food item from both the outside-in and the inside-out. Thus, cooking may occur while the oven 1 performs its normal cooking operation (e.g., infrared radiation, convection, conduction cooking). Alternatively, the probe 5 may be the sole heat source used to cook the food item, and the oven 1 may merely exist as a vessel in which the food item may be securely placed while the probe 5 is performing its cooking function. In another alternative embodiment, the probe 5 may be used while the food item is not in the oven, and instead rests on a plate, counter top, or other surface. It also may be used with other known or foreseeable appliances (e.g., pressure cooker, roaster, slow cooker, griddle) or other known or foreseeable cooking methods (e.g., pan-frying, conventional oven, grill).

In the embodiment illustrated in FIG. 1, the oven 1 includes traditional oven controls 10 which may be used to control oven functions. Such oven functions may include oven temperature, convection settings, cook times and timers, oven lights, and the like. Furthermore, the oven 1 preferably includes a heated probe control 15 that is in electronic communication with the probe 5. The probe control 15 may control a number of settings for the probe 5, including but not limited to: temperature, on/off, and duration of heat to be applied. The oven 1 of FIG. 1 further includes a temperature sensor 20 that may measure internal temperature of the food item in a manner similar to the probe 5, as set forth below. As such, the temperature sensor 20 is an optional element, and in some embodiments, the probe 5 may be sufficient for measuring the temperature of the food item.

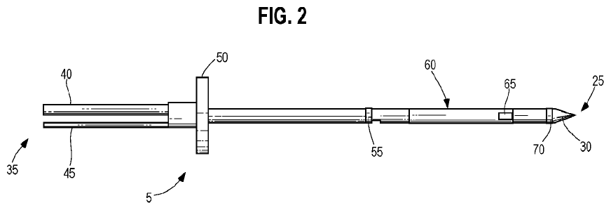

Turning now to FIG. 2, one embodiment of the probe 5 is illustrated in schematic form, in which the various components that make up the probe 5 are more clearly illustrated. At a distal end portion 25 of the probe 5, a pointed cap 30 is preferably provided for aiding insertion of the probe 5 into a food item. More particularly, the pointed cap 30 is preferably sufficiently pointed to penetrate foods ranging from breads and other baked goods to meats such as chicken or beef. At a proximal end portion 35 of the probe 5, two wire members 40, 45 may be provided. The wire member 40 is preferably a power wire such as those known and understood in the art that may be used to provide power to the probe 5. The wire member 45 is preferably a temperature control wire member that preferably provides control signals from the probe control 15 to the probe 5. In some embodiments, the wire members 40, 45 may be housed in a single sheath of insulation material.

Adjacent to the wires 40, 45 and closer to the distal end portion 25 of the probe 5, the probe 5 is provided with a stop member 50. The stop member 50 has a diameter somewhat greater than the diameter of rest of the probe 5 along the length of the probe 5. As such, the stop member 50 may act as a safeguard to prevent the probe 5 from being overly inserted into a food item. For example, the stop member 50 may help to prevent the wire members 40, 45 from coming into contact with the food item. The stop member 50 preferably further acts to prevent moisture from contacting the wire members 40, 45.

Distal to the stop member 50, the probe 5 is provided with a first food temperature thermistor 55. Next, adjacent to the first food temperature thermistor 55, a cartridge heater 60 is provided that includes a thermostat control 65. A second food temperature thermistor 70 may also be provided between the cartridge heater 60 and the pointed cap 30.

The first and second food temperature thermistors 55, 70 are optional, but when included act to measure the temperature of the food being cooked. Information regarding the temperature of the food that is captured by the thermistors 55, 70 may be provided to a user in any number of ways. Such temperature information may be displayed on the probe control 15 or elsewhere on the oven. In alternative embodiments, information from the thermistors 55, 70 may be otherwise transmitted to a wireless device such as a smart phone using known or foreseeable communication protocols. Temperature readings from one or both of the thermistors 55, 70, combined with data from the thermostat control 65, may be transmitted to the heated probe control 15. The heated probe control 15 may use such data to maintain, increase, decrease, or cease heat generated by the cartridge heater. Temperature captured by probes 55 and 70 may (with or without thermostat 65) provide information to a control board (not illustrated). The control board may be programmed with preset cooking modes and is preferably able to adjust temperature, power level, and time, depending on food type, cooking time, and doneness defined by the user in a control panel such as the oven controls 10 or the a heated probe control 15. In some embodiments, the control panel can include a mobile user device connected to the control board via a wireless network connection.

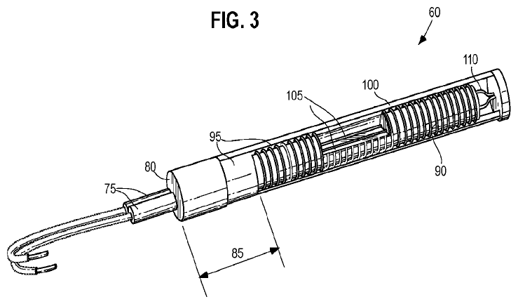

The cartridge heater 60, which is described in greater detail herein below and illustrated in FIG. 3, acts to introduce heat into the food item into which the probe 5 has been inserted. The thermostat control 65 can control the heat generated by the cartridge heater 60, as instructed by the probe control 15 via the temperature control wire member 45. Thermal insulation may be provided between the cartridge heater 60 and the thermistors 55, 70. Such thermal insulation may help the thermistors 55, 70 to more accurately read the temperature of the food item without undesired influence directly from the cartridge heater 60.

As illustrated in partial section view of FIG. 3, the cartridge heater 60 includes lead wires 75 that may be in communication with the wire member 40 and/or the wire member 45. The lead wires 75 may lead into the cartridge heater 60 at an end piece 80 that seals the lead wires in the cartridge heater 60. Adjacent to the lead wires 75 is a proximal section 85 of the cartridge heater 60 in which no heat is generated. This may prevent the connectors from overheating and damaging the seal. Other “no-heat regions” may be provided between the thermostat control 65 and thermistor 70 and the cartridge heater 60 and the thermistor 70. Those regions may isolate the thermocouple junctions (defined below) from the cartridge heater 60 so that an independent temperature reading can be taken. A resistance wire 90 is provided that may be used to generate heat. Within the cartridge heater 60, compacted magnesium oxide (MgO) insulation 95, or another type of suitable insulation, may be used to buffer the heat generated by the resistance wire 90 before reaching a sheath 100 at the outside surface of the cartridge heater 60. A communication wire or wires 105 may be used in communication with the resistance wire 90 as instructed by the lead wire 75 to generate heat in a known and understood manner. The wires 105 and resistance wire 90 may work with a thermocouple junction 110 to operate in a known manner to generate heat necessary to heat the cartridge heater 60 and subsequently a food item.

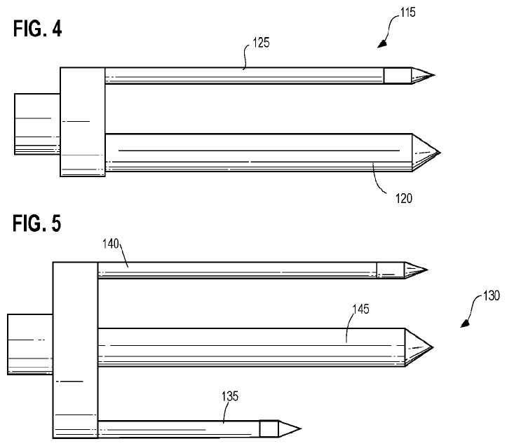

Turning to FIG. 4, an alternative heated probe 115 is provided. As seen in FIG. 4, the probe 115 bifurcates into a separate heat source and a food temperature sensor. As such, it includes an elongated heating probe 120 and an elongated food temperature probe 125. The heating probe 120 may operate in a manner substantially similar to the heating components of the probe 5 to heat the food to be cooked. Meanwhile, the food temperature probe 125 may act in a manner substantially similar to the temperature sensors of the probe 5 to measure the temperature of the food while the food is being cooked.

In FIG. 5, another alternative heating probe 130 is illustrated. Although the heating probe 130 functions similarly to the probe 5 and the probe 115, the heating probe 130 is provided with two food temperature sensor probes 135, 140, as well as a heating probe 145. As illustrated in FIG. 5, the first food temperature probe 135 is substantially shorter than the second food temperature sensor probe 140. Each of the sensors 135, 140 may be able to penetrate fully into a food item. In alternative embodiments, the food temperature sensor probes 135, 140 may be alternatively lengthened or shortened, as may the heating probe 145. Similarly, in alternative embodiments, more or fewer food temperature sensor probes such as the probes 135, 140 may be provided, or more heating probes such as the probe 145 may be provided.

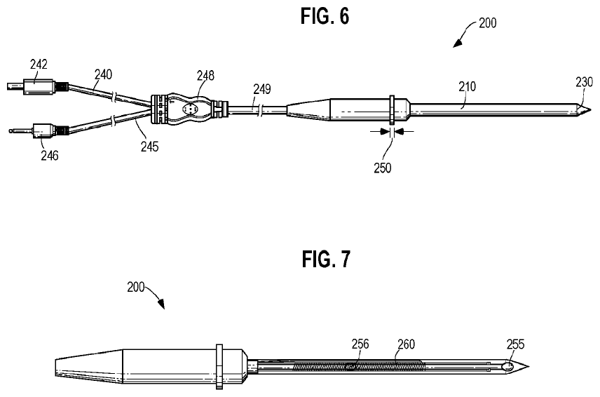

FIGS. 6-8 show another alternative heating probe 200 similar to the heating probes 5, 115, 130 shown in FIGS. 2-5. As seen in FIG. 6 the heating probe 200 can include a body 210 with a distal end portion 230 configured to aid in insertion of the probe 200 into a food product. Furthermore, as seen in FIG. 6, the probe 200 can include two wire members 240 and 245 for power and data respectively. In some embodiments, the wire members 240 and 245 can include different respective connectors 242 and 246. For example, in some embodiments, the connector 242 can include a female direct current power connector and the data connector can include a male 3.5 mm connector. As seen in FIG. 6, in some embodiments the wire members 240 and 245 can be merged together at a junction 248 into a common harness 249 for connecting to the probe 210. Additionally, in some embodiments, the probe 200 can include a stop member 250 similar to the stop member 50 of the probe 5 shown in FIG. 2.

FIG. 7 shows a partial phantom view of the internal components of the probe 200. As seen in FIG. 7, the probe 210 can include a heat element 260, a food temperature probe 255 for measuring a temperature of the food product into which the probe 210 is inserted, a heater temperature probe 256 for monitoring a temperature of the heat element 260.

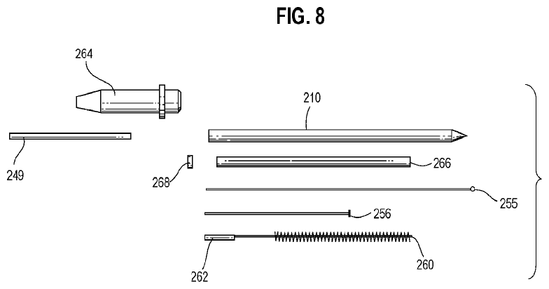

FIG. 8 shows an exploded view of some of the components of the probe 200. As seem in FIG. 8, in some embodiments, the heat element 260 can include nickel-chrome alloy heater wire arranged in a spiral configuration and including a terminal 262 that couples the heat element 260 to the power wire 240. When assembled, the heat element 260, the food temperature probe 255, and the heater temperature probe 256 can be at least partially contained within the body 210 by insulation 266 and a cap 268 and the body 210 can be secured to a boot section 264 to seal the heat element 260, the food temperature probe 255, and the heater temperature probe 256 within the body 210. In some embodiments, the food temperature probe 255 can extend beyond the insulation 266 into the distal end portion 230.

While the probes 5, 115, 130, and 200 may be made of a variety of materials, in any case, they are preferably be made at least partially of a material capable of conducting heat to a food item to be cooked. Similarly, as one skilled in the art may appreciate, the electronics and communication devices used in conjunction with any of the probes 5, 115, 130 may include methods and mechanisms both known and those foreseeable to those skilled in the art. Additionally, it should be noted that while the probes 5, 115, 130, and 200 are all described as having an internal heat element that activates when provided power by a power source additional embodiments where the respective heat element is omitted are also contemplated. For example, in some embodiments, an internal or external surface of any of the probes 5, 115, 130, and 200 can be manufactured from a material that heats up in response to electromagnetic waves directed towards the probe from the power source.

In some embodiments any of the probes 5, 115, 130, and 200 can be used in a particular method for cooking a food product. Such a method can include inserting any of the probes 5, 115, 130, and 200 into a food product and activating a power source such as a battery or the oven 1 of FIG. 1 to increase a temperature of the probe to a preconfigured temperature such that the temperature of the probe is a function of an amount of power supplied by the power source. For example, in some embodiments, the greater the amount of power provided by the power supply the higher the temperature of the probe will be as a result.

In some embodiments, the method can include a controller such as the oven controls 10, the heated probe control 15, and/or the control board discussed above receiving temperature readings of the food product altering the amount of power supplied by the power source in response to the temperature readings. For example, where the temperature readings indicate that the food product is heating too quickly the controller can decrease the power and where the food product is not heating quickly enough the controller can increase the power.

In some embodiments, the method can include the controller adjusting operating parameters of other cooking elements in response to the temperature readings. For example, in embodiments, where the power source is the oven 1, the other cooking elements can include one or more of a fan and/or a heating element of the oven 1. Additionally, in some embodiments, the controller can track an amount of time that the power source has been activated and can alter the amount of power supplied by the power source and/or adjust operating parameters of the other cooking elements in response to either or both of the amount of time and the temperature readings. For example, in embodiments where the controller modifies the amount of power supplied by the power source in response to the amount of time the power source has been activated, the controller can be programmed according to one or more profiles that correspond to a set of cooking operations and/or temperatures to be applied to the food product at different times. One non limiting example profile can include the controller operating the power source such that the probe temperature is initially 100 F for 5 mins to perform a defrost action, then 140 F for 30 mins to cook the food product, and then back down to 120 F for a remaining time to keep the food product warm. In some embodiments, the oven 1 of FIG. 1 can also be operated according to such profiles. The controller may therefore modulate the probe temperature by either increasing or decreasing power supplied to the probe either at a steady rate or stepwise, based on a preconfigured temperature profile, optionally further in view of measurement off the temperature or resistance of the foot (either at the top or along the edges of the probe).

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles, and scope of the present invention.

Many changes, modifications, variations, and other uses and applications of the present invention will, however, become apparent to those skilled in the art after considering the specification and the accompanying drawings. All such changes, modifications, variations, and other uses and applications which do not depart from the spirit and scope of the invention are deemed to be covered by the invention, which is limited only by the claims which follow.

What is claimed is:

1. A cooking system comprising:
a probe configured to be inserted into a food product; and
a power source that when activated is configured to increase a temperature of the probe to a preconfigured temperature such that the temperature of the probe is a function of an amount of power supplied by the power source.

2. The cooking system of claim 1 further comprising:
a heat element housed within a body of the probe, the heat element in communication with the power source for powering the heat element when the power source is activated,
wherein, when activated, the power source is configured to supply the amount of power to the heat element such that the heat element raises the temperature of the probe to the preconfigured temperature.

3. The cooking system of claim 1 wherein the probe includes a distal end portion for aiding insertion of the probe into a food product.

4. The cooking system of claim 2, wherein the heat element is a cartridge heater.

5. The cooking system of claim 2, wherein the probe includes a proximal end portion having a stop member, the stop member having a diameter greater than a diameter of the body so as to help prevent the probe from being over-inserted into the food product.

6. The cooking system of claim 1, wherein the probe further includes at least one thermistor to measure a temperature of the food product.

7. The cooking system of claim 1, wherein the probe includes a first heating probe body and a separate, first temperature sensing probe body.

8. The cooking system of claim 7, wherein the probe includes a second temperature sensing probe body.

9. The cooking system of claim 1, wherein the power source is included in an oven.

10. The cooking system of claim 9, wherein the oven includes a control panel for setting the preconfigured temperature and activating the power source.

11. The cooking system of claim 1, wherein the power source is a battery.

12. A method comprising:
inserting a probe into a food product; and
activating a power source to modulate a temperature of the probe to a preconfigured temperature such that the temperature of the probe is a function of an amount of power supplied by the power source.

13. The method of claim 12 further comprising:
receiving temperature readings of the food product at a controller for the power source; and
the controller altering the amount of power supplied by the power source in response to the temperature readings.

14. The method of claim 13 further comprising:
receiving the temperature readings of the food product from the probe.

15. The method of claim 13 further comprising:
receiving temperature readings of the food product from a first temperature sensing probe body of the probe which is separate from a first heating probe body of the probe.

16. The method of claim 13 further comprising:
the controller adjusting operating parameters of other cooking elements in response to the temperature readings.

17. The method of claim 16 wherein the power source and the other cooking elements are contained within an oven.

18. The method of claim 16 wherein the other cooking elements include one or more of a fan and an oven heating element.

19. The method of claim 16 further comprising:
the controller tracking an amount of time that the power source has been activated and altering the amount of power supplied by the power source and adjusting operating parameters of other cooking elements in response to both the amount of time and the temperature readings.

20. The method of claim 12 further comprising:
a controller for the power source tracking an amount of time that the power source has been activated; and
the controller modulating the amount of power supplied by the power source in response to the amount of time.
